(19) United States
(12) Patent Application Publication
(10) Pub. No.: US 2019/0147413 A1
(43) Pub. Date: May 16, 2019

(54) MAINTENANCE OPTIMIZATION SYSTEM THROUGH PREDICTIVE ANALYSIS AND USAGE INTENSITY

(71) Applicant: GE Energy Power Conversion Technology Ltd, Rugby (GB)

(72) Inventors: David Edmund JOHNSON, Houston, TX (US); Stuart GRAY, Houston, TX (US); Krishna UPPULURI, San Ramon, CA (US)

(21) Appl. No.: 15/810,223

(22) Filed: Nov. 13, 2017

(51) Int. Cl. G06Q 10/00

(52) U.S. Cl. CPC G06Q 10/20; G06N 7/005

(57) ABSTRACT

Provided is a method and system that includes a plurality of computing modules each configured to (i) retrieve maintenance history and equipment parameters associated with a plurality of equipment components from at least one network and process the maintenance history, (ii) calculate usage intensity based on the maintenance history and equipment parameters, and (iii) create modified maintenance schedules of the plurality of equipment components based on the maintenance history and usage intensity calculated.

### TECHNICAL FIELD

The present invention relates generally to performing equipment maintenance optimization. In particular, the present invention relates to performing offshore industrial equipment maintenance optimization through predictive analysis and usage intensity (UI).

### BACKGROUND

Traditional practices for maintaining industrial equipment systems usually include conducting regularly scheduled calendar-based preventative maintenance activities. An example of one such system is an offshore oil platform 10, illustrated in FIG. 1A.

The offshore oil platform 10 is an integrated system, including a drilling system 12, and marine vessels 14. The drilling system 12, includes various industrial equipment components, such as a drive train 16, blow out preventers (BOPS) 18, along with various management and control networks. Various other components—mud pumps, elevator systems, power systems, dollies, goose necks etc., are also industrial components within the integrated oil platform 10.

Given the remote and highly specialized nature of systems, such as the offshore oil platform 10, system maintenance can be very costly and difficult. One traditional cost containment and maintenance reduction approach combines the scheduled calendar based preventive maintenance, noted above, with limited amounts of required maintenance. In this approach, the required maintenance is performed after a specific number of hours run.

Although marginally effective, these traditional practices do not account for actual equipment conditions nor how extensively the equipment has been used over previous maintenance cycles. As a result, excessive and unnecessary maintenance can be performed on underutilized equipment, or equipment that has not been heavily utilized. At the same time, maintenance is not scheduled for equipment already exhibiting operational or performance anomalies, or in the process of actually failing.

### SUMMARY OF THE EMBODIMENTS

Given the aforementioned deficiencies, needed is a system and method for performing maintenance scheduling for offshore industrial equipment (e.g., motors, transformers etc.) within a maintenance network by monitoring associated equipment parameters and utilizing predictive maintenance modeling processes to detect signs of imminent equipment failure.

What is also needed are computerized maintenance systems capable of interfacing directly with existing preventative maintenance tracking systems. These computerized systems can postpone scheduled maintenance when it's not needed or the equipment is only occasionally used. Alternatively, maintenance schedules can be accelerated when anomalies, or other data, predict imminent equipment failure.

In embodiments of the present invention, a maintenance tracking system is provided. The system includes a plurality of computing modules each configured to (i) retrieve maintenance history and equipment parameters associated with a plurality of equipment from at least one network and process the maintenance history, (ii) calculate UI based on the maintenance history and equipment parameters, and (iii) create modified maintenance schedules of the plurality of equipment based on the maintenance history and UI calculated.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

FIG. 1A illustrates an offshore oil platform, in which embodiments of the present invention can be practiced.

FIG. 1B illustrates a tracking system for maintaining a plurality of industrial equipment systems on at least one network, in accordance with one or more embodiments of the present invention.

FIG. 2 illustrates a computing module of the system of FIG. 1B.

FIG. 3 illustrates an example of a modified maintenance schedule generated within the system of FIG. 1B.

FIG. 4 illustrates a skip and shift process of the system of FIG. 1B that can be implemented within the embodiments.

FIG. 5 illustrates maintenance histories of the plurality of plurality of equipment systems and maintenance benefits to be displayed to a user of the system of FIG. 1B.

FIG. 6 illustrates exemplary recordkeeping and reporting of effectiveness of modified maintenance schedules.

FIG. 7 illustrative a method for performing maintenance optimization through predictive analysis and usage intensity (UI).

FIG. 8 is a high level overview of maintenance optimization of a particular target asset.

FIG. 9 is a flowchart for smart signal predictive analytics (SSPA) according to an embodiment.

FIG. 10 is flowchart for a usage intensity factor analytics (UIFA) determination embodiment.

FIGS. 11A, 11B, and FIG. 12 illustrate exemplary UIFA calculation methods for very simple, simple, and complex apparatuses respectively.

FIG. 13 illustrates an exemplary overview diagram of maintenance rescheduling.

FIG. 14 is a graphical illustration correlating length of time and revolutions to wear.

FIG. 15 is an exemplary table including example mud flow rates.

FIG. 16A is a diagram illustrating an example of a maintenance timeline showing calendar scheduled maintenance vs. advanced maintenance vs extended maintenance.

FIG. 16B is a flowchart illustrating an example of skip & shift methodology, according to the embodiments.

FIG. 17 lists exemplary skip & shift methodology parameters.

FIG. 18 illustrates maintenance effectiveness analytics.

FIGS. 19A and 19B illustrate potential analytics combinations to drive data-driven predictive maintenance schedules.

### DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components.

In other instances, well-known components, apparatuses, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

As noted above, the embodiments provide a method and maintenance tracking system for performing maintenance scheduling for offshore industrial equipment (e.g., motors, transformers) within a maintenance network. This maintenance is performed by monitoring associated equipment parameters and utilizing similarity-based modeling processes to detect signs of imminent equipment failure.

The system described herein interfaces with existing equipment networks via a communication network. By way of example, the communication network can be WiFi, Internet, Bluetooth, 802.11, 802.15, cellular, or other computer networks. The maintenance system, according to embodiments of the present invention, interface directly with existing maintenance software systems well known to those of skill in the art.

Systems constructed in accordance with the embodiments generate additional maintenance and inspection tasks to resolve potentially problematic issues before they produce failures. As a result, this approach reduces costly repairs and unplanned downtime by calculating usage intensity (UI) for each equipment component or subsystem. The UI calculated assist with determining postponement of maintenance for lightly loaded equipment when downtime for maintenance is not required, resulting in extended equipment availability and overall reduced maintenance costs. The system of the embodiments can be implemented within existing marine and offshore equipment systems, and drilling ships. The system can also be implemented within any industrial plant power stations or other complex equipment systems.

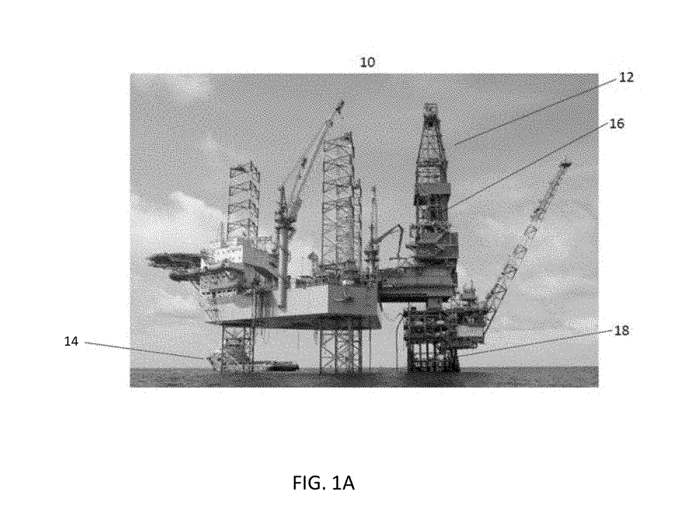

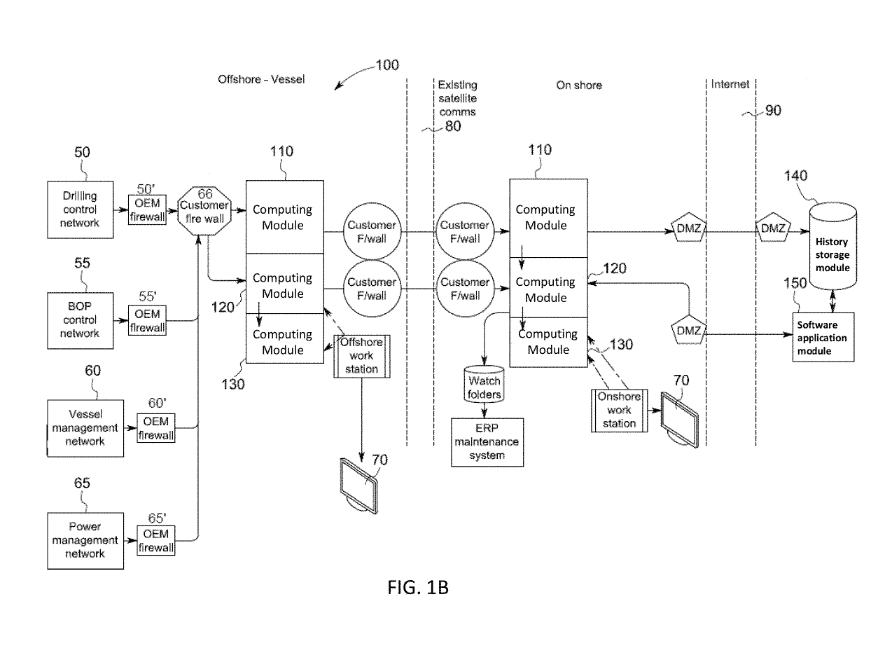

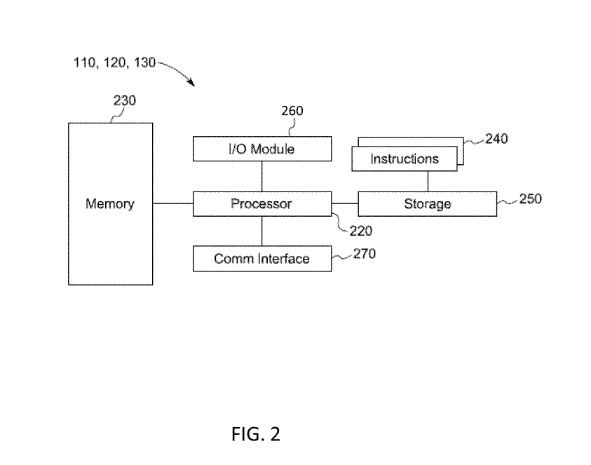

The embodiments will now be discussed with reference to FIGS. 1B and 2. FIG. 1B illustrates a tracking system 104 for maintaining a plurality of industrial equipment components on at least one network, according to the embodiments.

The system 100 of the present invention will be described in reference to an offshore vessel, for illustrative purposes only. As shown in FIG. 1B, the system 100 includes a plurality of computing modules 110, 120, and 130 in communication with a plurality of equipment networks 50, 55, 60, and 65. The system 100 further includes a storage database 140 and software application module 150 in communication with the computing modules 110 and 120.

By way of example only, and not limitation, the equipment networks 50, 55, 60, and 65 can include networks associated with drilling, BOP control, vessel management, and power management, respectively.

The computing modules 110, 120, and 130 can be virtual machines included within a single server, or single stand-alone servers or computing devices. In the example of FIG. 1B, the computing module 110 retrieves maintenance history data and equipment parameters associated with the plurality of industrial equipment systems associated via the networks 50, 55, 60, and 65.

As an example, the equipment parameters can include analog values such as temperature or pressure values, control signals, reference speeds, powers, torques and other feedback signals such as open/closed statuses, running stopped statuses, to name a few. The computing module 110 will process the maintenance history data input from the plurality of equipment systems.

The information received via the networks 50, 55, 60, and 65 passes through respective network firewalls 50′, 55′, 60′, and 65′ before being input to the computing module 110. Also included in the example of FIG. 1B is an optional customer firewall 66. The computing module 120 is configured to calculate a UI factor based on processed received maintenance history data and equipment parameter values output from the computing module 110.

The computing module 130 is configured to create modified maintenance schedules of the plurality of equipment based on the maintenance history and UI calculated via computing modules 110, 120, and 130. The modified maintenance schedules can be displayed via a user interface (e.g., a computer display 70).

As shown in FIG. 1B, in accordance with one embodiment, the networks 50, 55, 60 and 65 and the computing modules 110, 120, and 130 can be located offshore on a vessel and a second set of computing modules 110, 120, and 130 can be disposed onshore in a remote location for further analysis. The computing modules 110, 120, and 130 offshore can communicate with the computing modules 110, 120, and 130 onshore via an existing satellite communication network 80.

Functions performed by the computing modules 110, 120, and 130 onshore are substantially identical to the functions performed by the computing modules 110, 120, and 130 offshore. The resulting modified maintenance schedules can also be displayed on an onshore user interface 70. The information can be sent to the storage module 140 and viewed and controlled via the software application module 150 at a user device. The information sent to the storage module 140 and the software application module 150 can first go through a demilitarized zone (DMZ) or additional firewalls.

According to one or more embodiments, the storage module 140 and the software application module 150 can be located at an industrial performance and reliability center (IPRC) and information is retrieved from the computing modules 110, 120, and 130 onshore via a communication network 90 such as the Internet.

Each computing module 110, 120, and 130 each can be a computing device as shown in FIG. 2 that includes a processor 220 with a specific structure. The specific structure is imparted to the processor 220 by instructions stored in an internal memory 230 included therein. The structure can also be imparted by instructions 240 that can be fetched by the processor 220 from a storage medium 250. The storage medium 250 may be co-located with the computing module 110, 120, and 130 as shown, or it may be located elsewhere and be communicatively coupled to the respective computing module 110, 120, and 130.

The computing modules 110, 120, and 130 each may include one or more hardware and/or software components configured to fetch, decode, execute, store, analyze, distribute, evaluate, diagnose, and/or categorize information. Furthermore, the computing modules 110, 120, and 130 can each include an input/output (I/O) module 260 that can be configured to interface with each other and with the external networks.

The processor 220 may include one or more processing devices or cores (not shown). In some embodiments, the processor 220 can be a plurality of processors, each having either one or more cores. The processor 220 can be configured to execute instructions fetched from the memory 230, or the instructions may be fetched from storage medium 250, or from a remote device connected to computing device via a communication interface 270.

Furthermore, without loss of generality, the storage medium 250 and/or the memory 230 may include a volatile or non-volatile, magnetic, semiconductor, tape, optical, removable, non-removable, read-only, random-access, or any type of non-transitory computer-readable computer medium. The storage medium 250 and/or the memory 230 may include programs and/or other information that may be used by the processor 220.

Moreover, the storage medium 250 may be configured to log data processed, recorded, or collected during the operation of the computing modules 110, 120, or 130. For example, the storage medium 250 may store the historical data, calculated UI data, and created modified maintenance schedule data at the respective computing modules 110, 120, and 130. The data may be time-stamped, location-stamped, cataloged, indexed, or organized in a variety of ways consistent with data storage practice.

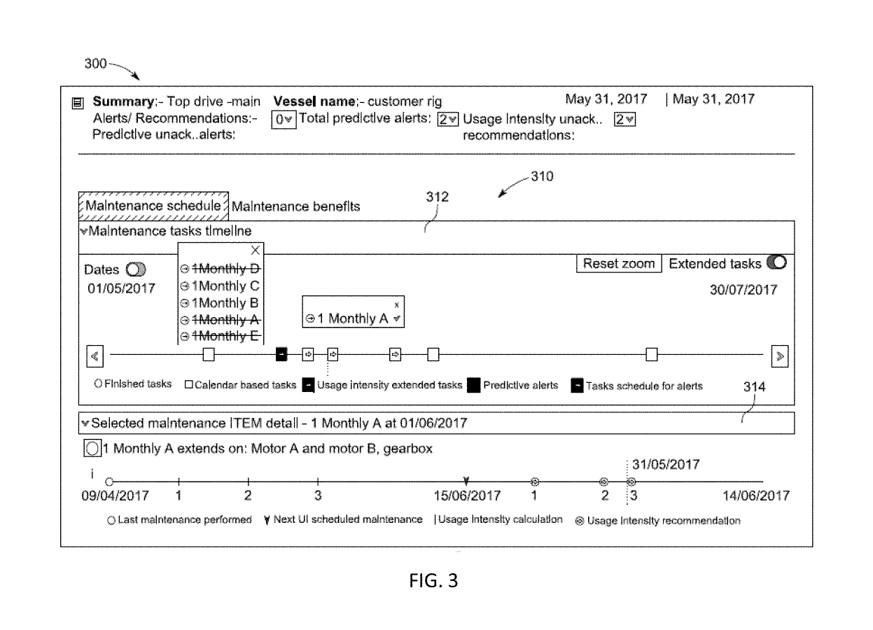

FIG. 3 is a chart illustrating an example of a modified maintenance schedule generated within the system of FIG. 1B that can be implemented within one or more embodiments. As shown in chart 300, the modified maintenance schedule 310 includes a maintenance task timeline 312 and a selected item task detail 314. As shown in the maintenance task timeline 312 including finished-base tasks, calendar-based tasks, UI extended tasks and predictive alerts, and tasks scheduled alerts, for example. The maintenance task timeline 312 illustrates the overall maintenance tasks necessary for a network including a plurality of equipment. The selected item task detail 314 illustrates maintenance for a specific piece of equipment of the plurality of equipment.

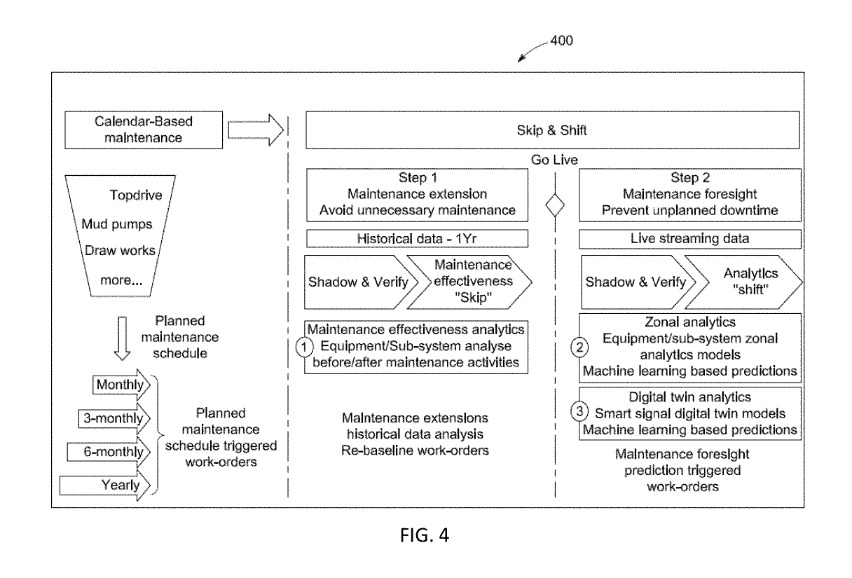

The system 100 shown in FIG. 1B, can employ a skip shift process to determine when to extend or verify existing maintenance tasks. FIG. 4 is a flow diagram illustrating the skip and shift process 400 of the system 100 of FIG. 1B. The skip shift process 400 is performed on different types of equipment, for example, top drives, and mud pumps etc. Existing maintenance tracking systems typically include calendar-based maintenance that include a planned maintenance schedule to be performed monthly, every three-months, six-months, yearly, and the like.

As shown in step 1, the skip shift process 400 includes determining maintenance extensions to avoid unnecessary maintenance. By way of example, this determination can be based upon the historical data for a one (1) year period, as received from the networks 50, 55, 60, and 65 by the computing module 110 of FIG. 1B. The maintenance of the industrial equipment components is shadowed and verified and based on maintenance effectiveness a “skip.” A skip is performed such that the routine scheduled maintenance can be skipped without damage to the equipment. The maintenance effectiveness analytics performed can include equipment analysis before and after the maintenance activities.

In step 2 of the skip shift process 400, maintenance foresight is performed to prevent unplanned downtime of the equipment by prediction of necessary maintenance. Data regarding the equipment is live streamed to the computing module 110, and the maintenance of the equipment is shadowed and verified by analysis. The analytics can be zonal analytics which include equipment zonal models and use of machine learning based predictions.

Further, predictive maintenance analysis using machine learning based predictions can be performed. Based on the analytics, a shift of the maintenance schedule is performed.

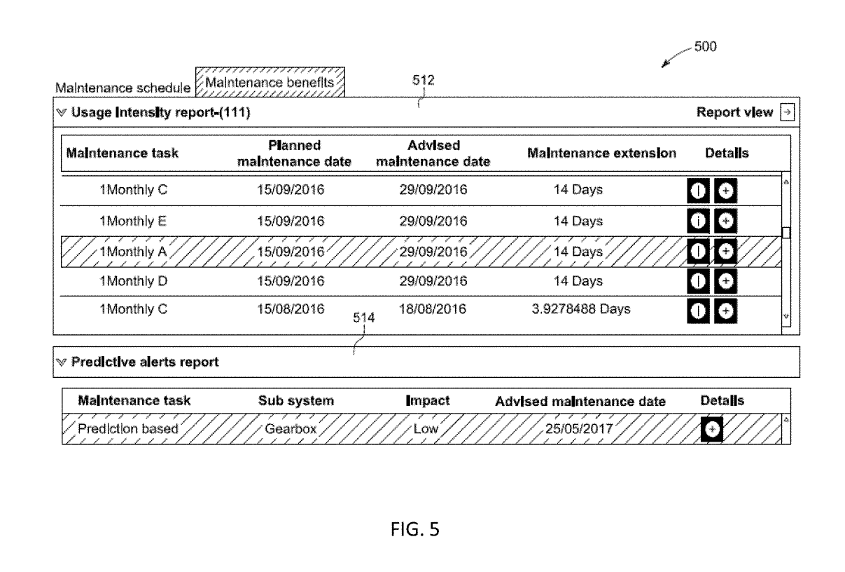

FIG. 5 is an exemplary chart 500, illustrating maintenance histories of the industrial equipment components and maintenance benefits to be displayed to a user at the user interface 70, such as a workstation. The chart 500 includes maintenance benefit information including a UI report 512, and a predictive alerts report 514.

The UI report 512 includes the maintenance task, planned maintenance data, an advised maintenance date, and the calculated maintenance extension (i.e., the number of days extended) for each maintenance task. The predictive alerts report 514 can also include the type of maintenance task, the subsystem or equipment (e.g., a gearbox), the impact of the maintenance extension (e.g., low), and/or the advised maintenance date.

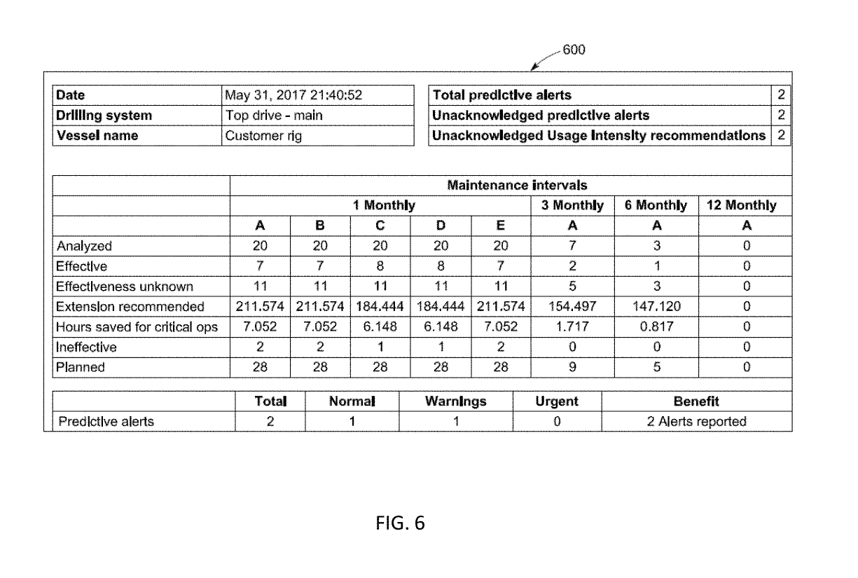

FIG. 6 is an exemplary chart 600 illustrating recordkeeping and reporting of effectiveness of modified maintenance schedules in accordance with the embodiments. As shown in the chart 600, within any given equipment component system, the number of pieces of equipment analyzed can be calculated, along with the effective modified maintenance schedules, and the unknown effectiveness. Additionally, total extension days determined, man hours saved, ineffective maintenance extensions, and planned maintenance can be calculated. The report data can be displayed and analyzed by operators at the user interface 70 for purposes of determining the effectiveness and accuracy of the system 100.

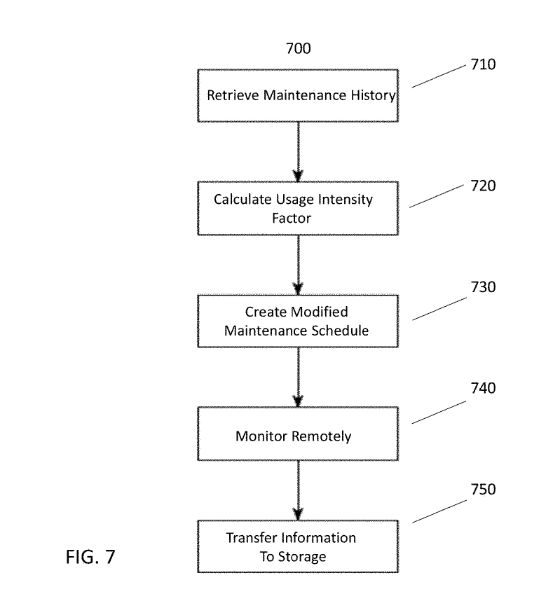

FIG. 7 is a flow diagram illustrating an exemplary method 700 for performing maintenance optimization through predictive analysis and UI that can be implemented within one or more embodiments of the present invention in reference to FIG. 1B. The method begins at operation 710 where the computing module 110 retrieves maintenance history and equipment parameters associated with the equipment components via the networks 50, 55, 60, and 65. The computing module 110 then processes the maintenance history of the industrial equipment components.

From operation 710, the process continues to operation 720 where the computing module 120 then calculates usage intensity factor (UIF) based on the maintenance history and equipment parameter values retrieved by the computing module 110. From operation 720, the process continues to operation 730 where the computing module 130 is configured to create modified maintenance schedules of the industrial equipment components. The modifications are created as a function of the maintenance history and UI, calculated via computing modules 110, 120, and 130. The modified maintenance schedules can be displayed via the user interface 70.

From operation 730, the process proceeds to operation 740 where this process is duplicated in the case of remote monitoring. From operation 740 the process continues to operation 750 where the information, including the modified maintenance schedules, maintenance history etc., is transferred to the storage module 140 and retrievable and controllable by an operator via the software application module 150.

Embodiments of the present invention provide the advantages of generating additional maintenance and inspection tasks to resolve issues before breakdown to reduced unplanned downtime and repairs. The embodiments use principles of big data management to bring maintenance optimization to an enterprise level, providing visibility of maintenance requirements, schedules and equipment conditions to a centralized location allowing maintenance analysis and optimization to be performed. The embodiments allow an operator to extend maintenance of equipment with the knowledge that any abnormalities will be detected prior to a failure occurrence.

### Exemplary Virtual Machine Embodiments

The embodiments, discussed in more detail below, are for illustrative purposes and not meant to be limiting. A person ordinarily skilled in the art (POSITA) would recognize that certain changes (e.g., in geo-spatial disposition of various measuring, tracking, and computing modules etc.) would be within the scope of the disclosed invention.

Herein, the terms artisan, routineer, and POSITA may be used interchangeably. The term target asset will be used generically to refer to a single piece of equipment (e.g., a motor or gear) or to more complex equipment having pluralities of components. The terms computer, processor, and virtual machine may be used interchangeably. The term communication interface will be used generically to include LAN/WiFi, WAN, cloud, Internet, dedicated/private communications links, etc. The terms data and information will be used interchangeably.

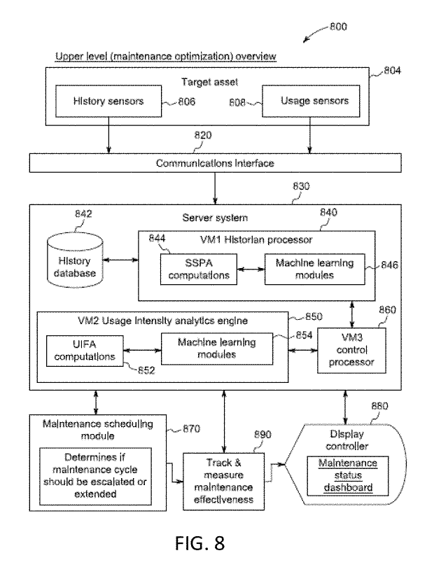

FIG. 8 provides an upper level overview of the disclosed system 800, as applied for one network (such as anyone of networks 50, 55, 60, 65 in FIG. 1B). This is not meant to limit the scope of the disclosed system to use with just one network, as the principles disclosed herein could be similarly, and/or simultaneously, used (under either local/distributed or remote centralized control) for a plurality of networks as those indicated in FIG. 1B.

The system 800 includes a target asset (TA) 804 as comprising history sensors 806 and usage sensors 808. An artisan would of course recognize that such sensors could be physically located either locally (i.e., in or on the TA) or be operatively coupled to remote/central monitors, through a communications interface 820.

History & usage sensory signals (further explained below) from TA 804 are received by element 830, which represents a computing/server system. In this particular embodiment, the server includes three virtual machines (VM1-element 844, VM2-element 850, VM3-element 860). Equivalent/alternative server configurations would be recognized by the artisan as within the scope of the disclosed invention.

VM1 is an historian processor 840. It includes a smart signal predictive analytics (SSPA) module 844. VM1 performs SSPA maintenance computations, using both incoming and stored 842 history data, in conjunction with analytics from its machine learning modules 846. VM1 combines this information to make TA performance/failure predictions, for maintaining a selected TA. For example, VM1 may compare current behavior with predicted values developed from similarity based modelling for various operating modes.

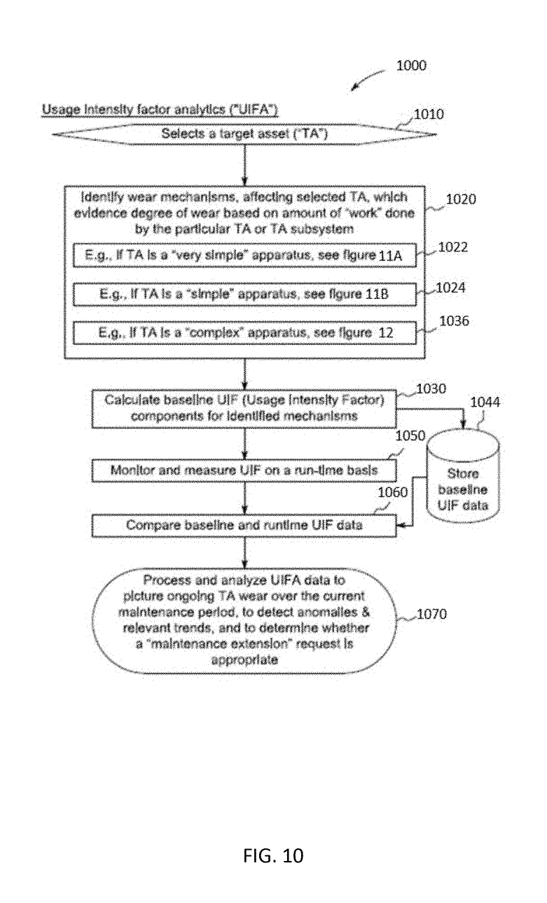

VM2 is a UI analytics engine 850. VM2 850 includes a UI factor analytics (UIFA) module 852. VM2 performs UIFA computations using model behavior data (for equipment in the same class as the TA of interest), incoming sensory and stored usage data, and analytics from its own machine learning modules 854. For example, VM2 may compare (e.g., FIG. 10) sensed usage data, which indicates the actual amount of wear or work performed, with model baseline data developed for the specific type of TA apparatus (e.g., FIGS. 10 and 11-12).

VM3 is a control processor 860. VM3 combines information from VM1 and VM2 and manages maintenance tracking and scheduling 870. VM3 also uses the historical and calculated data to drive dashboards providing meaningful information on maintenance status of covered equipment, and VM3 860 controls displays 880 and interactions with operators. While depicted as separate from the control processor 860; a POSITA would recognize that elements 870, 880, and 890 may be equivalently configured as physically part of the control processor, or geo-spatially removed from the control processor but operatively coupled thereto.

A POSITA would also recognize that some calculations, determinations, and computations ascribed to one part of the server-system could be performed in one or more other parts of the server-system without departing from the scope of the disclosed invention.

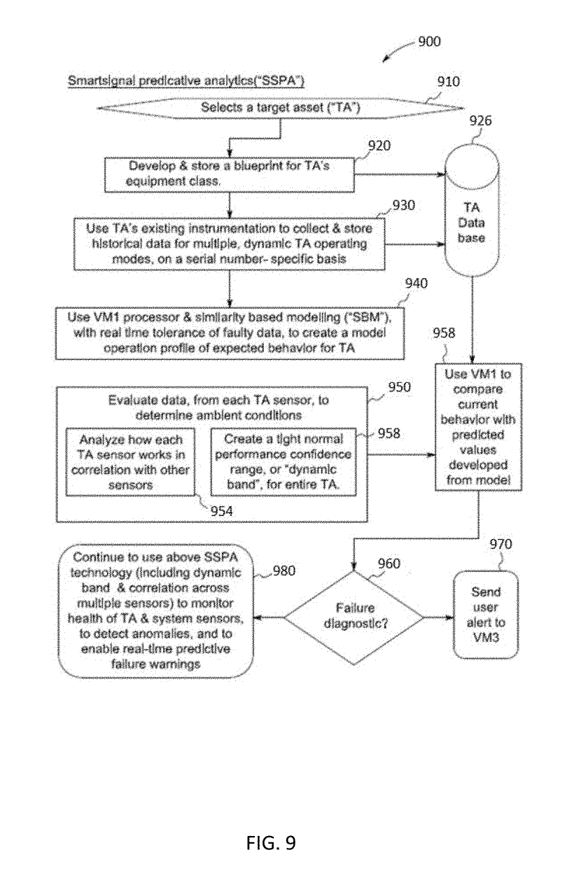

FIG. 9 is a flowchart for an SSPA determination embodiment 900 using a blueprint model. After a TA of interest is selected 910, a blueprint for the TA's equipment class is developed 920 and stored 926. Next, the TA's existing instrumentation 930 is used to collect historical data for multiple operating modes on a serial number basis.

Thus, the routineer would recognize that one (both cost and convenience) benefit, of the disclosed solution, is that special/additional instrumentation is NOT required since existing instrumentation is employed for this data collection phase. Moreover, the disclosed SSPA system uses only historical operating data rather than detailed process or equipment engineering data.

In step 940, the VM1 processor is used to implement SBM to create and store 926 a dynamic expected operating profile for the TA. At step 950, the VM1 processor evaluates data from each of multiple sensors, calculates ambient conditions, and determines how each TA sensor works in correlation with other sensors 954. The VMI processor also creates a tight normal performance confidence range, or dynamic band 957, for the entire TA. At step 958, the VM1 may be used to compare current behavior with predicted values from the prior developed model. The system determines whether a failure diagnostic has been detected 960. In the example of FIG. 9, if the answer is YES, a user alert 970 is sent via VM3.

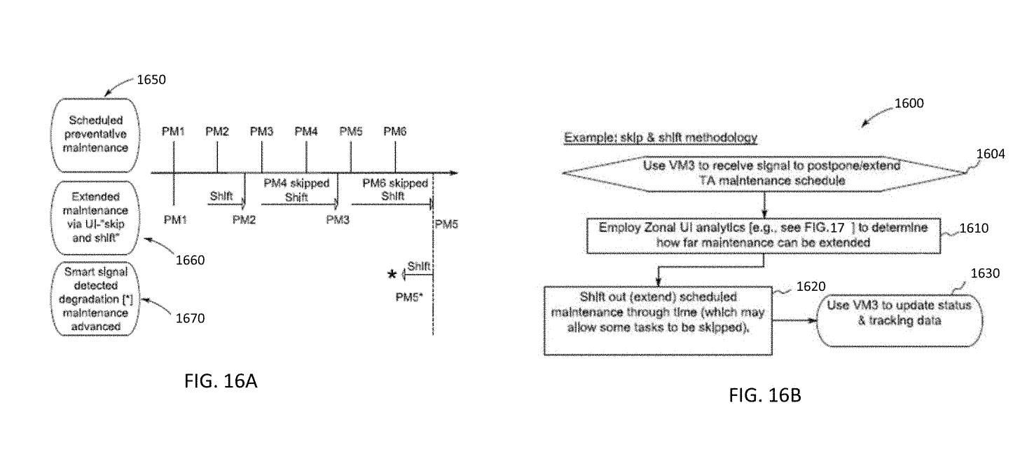

If the answer is NO 964, then use of the SSPA technology continues 980 for monitoring the health of the TA and for detection of anomalies, to enable real-time predictive failure warnings. Thus, using SSPA allows users to continuously monitor equipment performance and detect any degradation 1670. This provides advanced warnings of potential failure, often early enough to recommend carrying out additional maintenance inspections or tasks during an upcoming maintenance (e.g., see PM5 shift, at FIG. 16B).

### Usage Intensity Factor Analytics Details

FIG. 10 is flowchart 1000 for an embodiment employing UIFA determinations. Once a target asset is selected 1010, and an understanding of the wear mechanisms affecting an item of equipment are identified 1020, it is possible to identify measures (e.g., 1022, 1024, 1036) of how intensively the equipment has been used. Accordingly, its maintenance schedule can be modified 1070 in relation to the amount of wear experienced.

Other maintenance systems consider the number of hours equipment has been run as a measure of its usage, which does not take into account the amount of work the equipment does while it is running. The approach described herein looks in depth at the equipment operation to define the wear mechanisms.

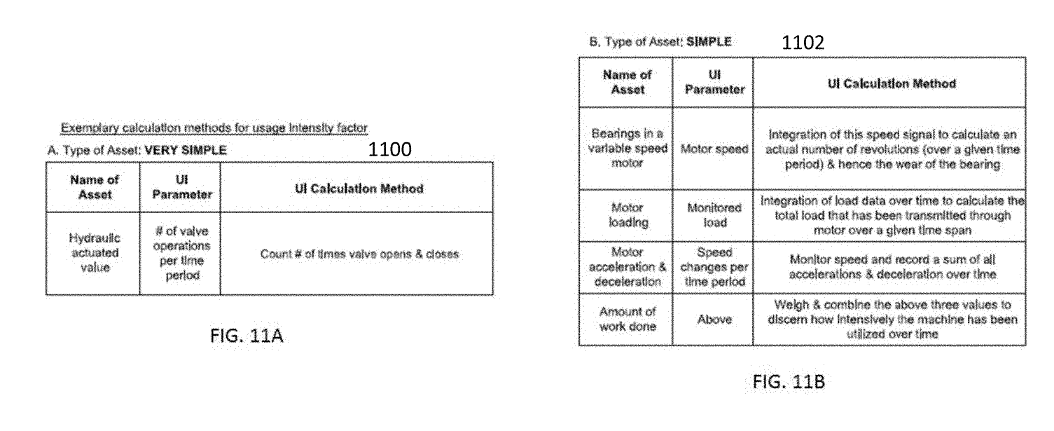

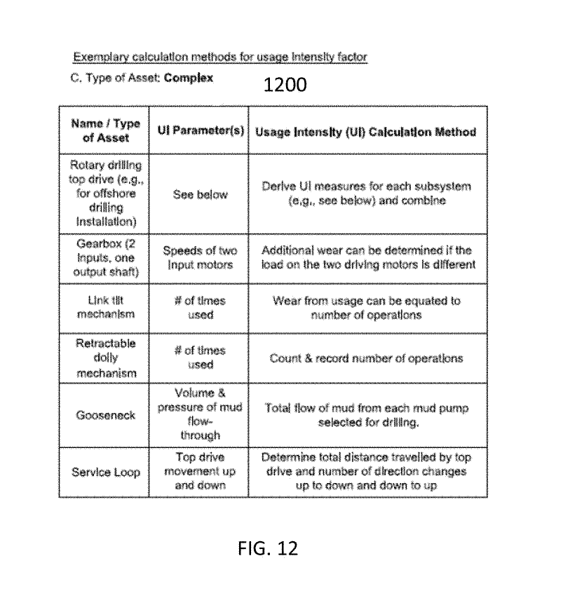

FIGS. 11A, 11B, and FIG. 12 illustrate UIFA calculation methods for very simple 1100, simple 1102, and complex apparatuses 1200, respectively. When initially configuring the system, to ensure the most representative calculations of wear are carried out, wear mechanisms are examined on a case by case basis for each target asset. For example: if the TA is a very simple apparatus (e.g., a valve), see FIG. 11A; if the TA is a simple apparatus (e.g., bearings), see FIG. 11B; if the TA is a complex apparatus, such as a gearbox, see FIG. 12.

Continuing with FIG. 10, using the wear mechanisms identified at step 1020, baseline usage intensity factor (UIF) components are calculated 1030 and stored 1044. The UIF parameters can then be monitored and measured on a real-time basis 1050. Comparisons are then made between the baseline and run-time UIF data 1060.

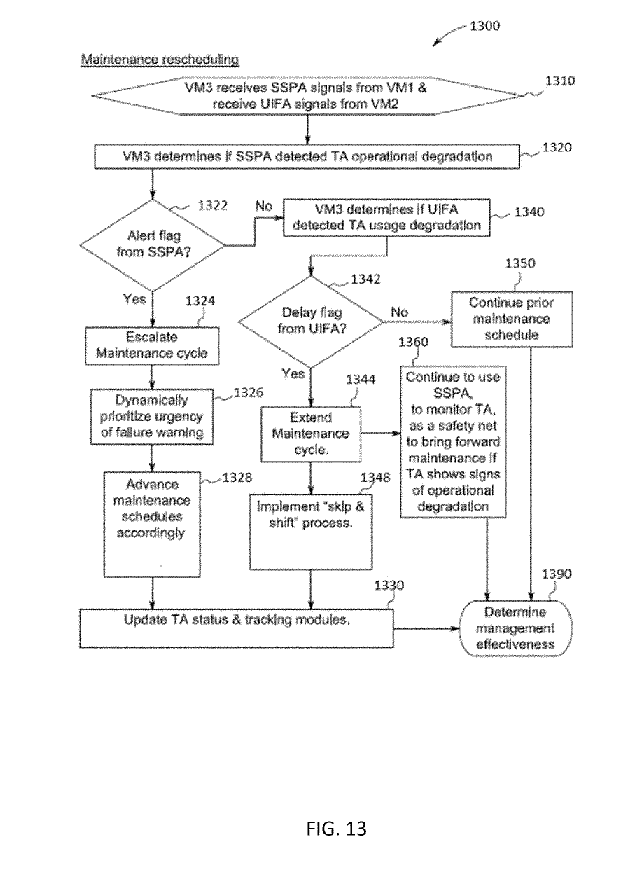

VM2 can thus be used to process and analyze the UIFA data to picture ongoing TA wear, over the current maintenance period. Thereby, this UIF data processing also allows detection of anomalies and relevant trends 1070. The results of the UIF analysis further enables determination of whether a maintenance extension request is appropriate (e.g., FIG. 13). More detailed example UIF calculations are provided below.

The top drive power mechanism, noted above, consists of multiple components, including two motors: motor A and motor B. Motor A and Motor B are brought together into a dual input bull and pinion gearbox, depicted in FIG. 3. Each motor and the gearbox can be viewed independently for performing predictive maintenance and intensity usage calculations. Although calculations are performed on a case-by-case basis, several calculations performed in the examples below, are common to all systems.

The system 100 of FIG. 1B may detect a problem within and recommend maintenance on one or more of the components. As a result, it may be necessary to track maintenance on each of the components independently. For example, the system 100 may indicate a problem with bearings in motor A and may elect to perform maintenance on motor A only, leaving motor B unchanged.

For purposes of illustration, consider wear on the top drive train (motors, gearbox, coupling, etc.). Wear on top of the drive train has a direct relationship to the number of revolutions of the motor. Revolutions of the motor correlate to running time and running speed. Calculating the number of revolutions is accomplished in the same manner for motor A, motor B, and the gearbox.

In a first example calculation, the system 100 can track top drive motor and gearbox utilization, based upon predictive maintenance, in accordance with the embodiments. The utilization can be determined by considering total hours run and the actual number of revolutions of each motor, or the gearbox, since last maintenance. The utilization can be calculated as a function of the number of revolutions (N). In the present example, the utilization can be calculated by integrating rotational speed in accordance with the expression

N=∫_{t=T0}^{t=Tcur}ω(t)dt

where N=total number of revolutions between time 0 and current time
Tcur=current time
T₀=time of performance of last maintenance
ω=angular velocity

By analysis of the historical data, the maximum number of revolutions in any six (6) week period will be Revₘₐₓ. Software, within the system 100, is configured to count the total number of revolutions after three (3) weeks. This count is used to project the length of time required to reach the same value of Revₘₐₓ, which represents the maximum possible extension of maintenance.

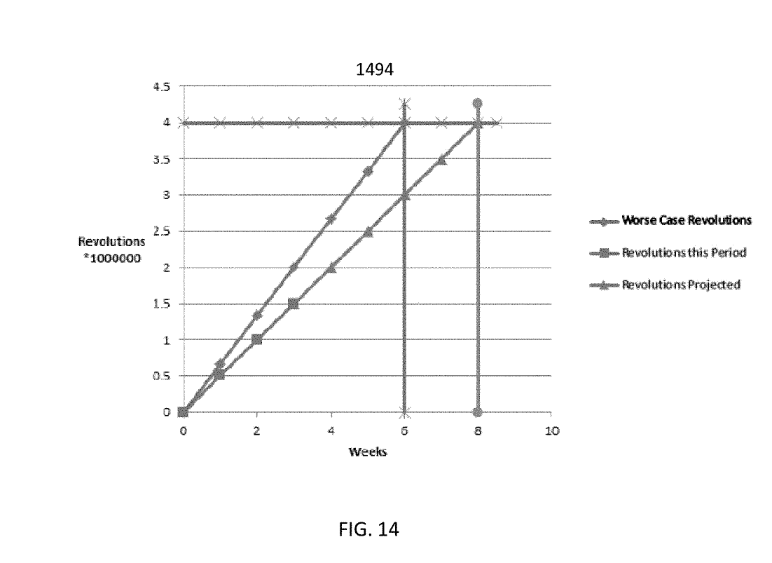

In this first example, the maximum possible extension can initially be limited to 30%. The extension will be re-evaluated periodically (e.g., weekly), up to a point where maintenance is performed. This process is illustrated in a graph 1494 shown in FIG. 14. Once maintenance has been performed, the count of the number of revolutions is desirably reset to zero (0).

In a second example, total power transmission can be calculated, based upon predictive maintenance, according to the embodiments. Just as revolutions of the motor correlate to running time and running speed, discussed above, the integral of drive powers correlates to total energy transmitted through the top drive. In this example, total power transmission can be calculated as

Pₛᵤₘ=∫_{t=T0}^{T=Tcur}[P₁(t)+P₂(t)]dt

Where Pₛᵤₘ=sum of power passed through topdrive
Tcur=current time
T₀=time of performance of last maintenance
P₁=motor 1 power
P₂=motor 2 Power

By analysis of vessel historical data, the highest value of power transmitted in any six (6) week period can be calculated as Powₘₐₓ. Software within the system 100 measures a total value power transmitted after three (3) weeks. This measurement value can be used to project the length of time required to reach the same value of Powₘₐₓ, which represents the maximum possible extension of maintenance. This process correlates to the maximum maintenance extension.

In the second example, the maximum maintenance extension is initially limited to a maximum extension of 30%. The possibility of extending maintenance will be re-evaluated periodically (e.g., weekly), up to a point where maintenance is performed. Once maintenance has been performed, the measurement value of the power flow is desirably reset to zero (0).

In yet a third example, the system 100 can calculate stress factors by considering the acceleration of the motors A and B. If the speed of the motors is oscillating rapidly, the top drive will be subject to additional harmful stresses. Conversely, if the speed is steady, there will be less stress on the system. In this example, angular acceleration is calculated as the differential of angular velocity. As such, the average of acceleration over the period, since maintenance was last performed, can be used as a stress multiplier when considering maintenance extension. The average acceleration can be calculated as

$$S = \frac{{\sum }_{n = T 0}^{n = Tcur} [ \frac{d ω}{dt} ]}{n}$$

where S=stress factor, representing averaged acceleration
Tcur=current time
T₀=time when last maintenance was carried out
ω=angular velocity

By analysis of Integrator data, we find the highest value of acceleration stress in any six (6) week period as being Accmax. Software, within the system 100, measures the value of the total power transmitted after three (3) weeks. This measurement value can be used to project the length of time required to reach the same value of Accmax., which represents the maximum possible extension of maintenance.

In the third example, the maximum maintenance extension is again initially limited to a maximum extension of 30%. The possibly of extending maintenance will be re-evaluated periodically (e.g., weekly), up to a point where maintenance is performed. Once maintenance has been performed, the measurement value of the acceleration stress is reset to zero (0).

In one other example, a few calculations for predictive maintenance of inside blow out preventer (IBOP) are illustrated. IBOP maintenance is desirably performed periodically, for example, monthly or every few months. The need to perform maintenance on the IBOP is related to two areas.

Wear occurs as a result of IBOP operation. Therefore, by maintaining a count of the number of IBOP operations since the last maintenance was performed, an assessment of the number of operational cycles that can be accomplished before maintenance is required, can be developed. When maintenance is performed on the IBOP, the operational count is reset to zero (0).

A full cycle of the IBOP is equivalent to a transition from open to close, and back to open. By analysis of integrator data, the IBOP operational count within any six (6) week period as being IBOPₘₐₓ. Similar to the descriptions above, software within the system 100 counts the total number of operations after three (3) weeks. This count is used to project the length of time required to reach the same value of IBOPₘₐₓ.

Projecting this length of time provides the maximum extension of maintenance—initially limited to a maximum extension of 30%. As discussed earlier, the possibility of extending maintenance will be re-evaluated periodically (e.g., weekly), up to a point where maintenance is performed. Once maintenance has been performed, IBOP operations will be reset to zero (0).

A goose-neck is another component, subjected to wear, for which predictive maintenance would be particularly advantageous. As understood to those of skill in the art, a goose-neck is a thick metal elbow that interacts with other components to support the weight of high pressure hoses. A major cause for wear on the goose-neck is mud flowing through it, which erodes the inner surfaces of the pipe. Goose-necks are typically replaced rather than maintained. This exercise can be especially costly when unworn, and still functional goose-necks, are replaced.

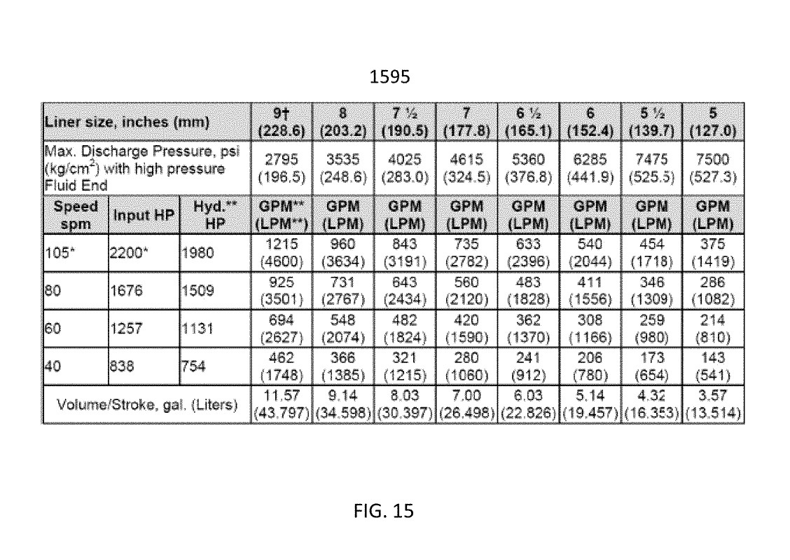

With information, such as the number of mud pump strokes per minute and pump liner size, the flow of mud being pumped can be calculated using table 1595 in FIG. 15, as shown below. Table 1595 provides values related to gallons per minute (strokes per minute multiplied by volume per stroke) of mud flow.

The inventors of the present application have observed that total wear on the goose-neck is proportional to the volume of mud flowing through it. One approach to calculating the total volume of mud through the goose-neck is to integrate the flow over time using the expression

V=∫_{t=T0}^{t=Tcur}Fdt

where V_{T}=Total volume of mud in current maintenance period
Tcur=current time
T₀=time when last maintenance was carried out
F=mud flow=pump speed (stokes per minute)×stroke volume (m cubed)

By analysis of historical data, we see the highest mud volume passed through gooseneck in any (six) 6 week period as being Mudₘₐₓ. Software, within the system 100, measures the value of the total mud flow after three (3) weeks and uses this value to project how long it will take to reach the same value of Mudₘₐₓ. This measurement value can be used to project the length of time required to reach the same value of Accmax., which represents the maximum possible extension of maintenance.

Software, within the system 100, analyzes the total mud flow after three (3) weeks and uses this to project the amount of time required to reach the same value of Mudₘₐₓ. This process depicts the maximum maintenance extension—which will be initially limited to a maximum extension of 30%. In the present example, the extension will be re-evaluated periodically (e.g., weekly) up to the point where maintenance is carried out.

### Maintenance Rationalization

Returning to FIG. 13, an overview diagram illustrating maintenance rationalization and rescheduling 1300 is provided. Once the wear mechanisms are identified in a piece of equipment or component, it is possible to review the equipment recommended maintenance procedures in detail to map each maintenance task to the equipment wear it is trying to mitigate. Historical data is analyzed to look at the maximum usages the equipment has seen over a typical operating cycle. This forms the basis for being able to extend individual maintenance tasks if the associated UIs are less than derived maximums.

Traditional schedule-based maintenance typically covers maintenance for equipment designed to run at high loads for extended periods of time. Often equipment is operated at far lighter loads than the design nominal; hence the equipment is subject to less wear and needs less frequent maintenance. If necessary recommended maintenance activities, which fall under a scheduled maintenance event, can be reorganized in line with findings. Maintenance events can be extended (or delayed/postponed) in line with usage provided from historical analyses.

### Maintenance Rescheduling

On the FIG. 13 flowchart at step 1310, VM3 receives SSPA signals (from VM1) and UIFA signals (from VM2). VM3 then determines if SSPA detected TA operational degradation 1320. If an alert flag has been received from SSPA 1322, then VM3 calls for escalating the TA's maintenance cycle 1324 and performing the necessary maintenance event at an earlier time than previously scheduled.

VM3 also dynamically prioritizes the urgency of the received failure warning 1326. If a more urgent problem is identified after review by subject matter experts, an automatic maintenance request would be submitted to the maintenance system controller, thereby triggering appropriate corrective responses.

The system then advances 1328 the TA's maintenance schedule accordingly 1670. Updates are then transmitted to the TA status and tracking modules. (E.g., see FIG. 16A.) This information is also used in determining management effectiveness 1390.

If no SSPA flag is detected 1322, VM3 determines if the UIFA signals (which indicate ongoing equipment usage) include recommended delays or extensions of one or more TA maintenance events 1340. If no delay/extension flag is detected, maintenance continues as previously scheduled 1350.

If a delay flag has been received from UIFA 1342, then VM3 can call for an extension (or stretching-out) of the TA's maintenance schedule 1344. During the extension period, the system continues to use SSPA to monitor the TA as a safety net. Thereby, maintenance events can be brought forward if TA shows signs of degradation during the extension period 1360.

Receipt of a flag indicating that a maintenance event may be delayed actuates computations to determine if implementation of a “skip & shift” process 1348 is appropriate; and if so, for how long. (e.g., see FIGS. 3-5, 16A, and 16B). In addition, TA status and tracking information is updated 1330 and data is generated for determining management effectiveness 1390.

### Skip & Shift Methodology

FIG. 16B is an overview flowchart illustrating an example of skip & Shift method 1600. Skip and shift refers to the way scheduled preventative maintenance can be shifted out (extended), based on equipment UI. In the method 1600, by way of example, VM3 860 receives a scheduling signal 1604. As maintenance is extended through time, some tasks can be skipped 1620. Combining UIFA and SSPA allows a unique mechanism to extend or postpone maintenance periods, resulting in reduced maintenance down time and reduced material costs. In step 1630, VM3 860 updates status and tracking data.

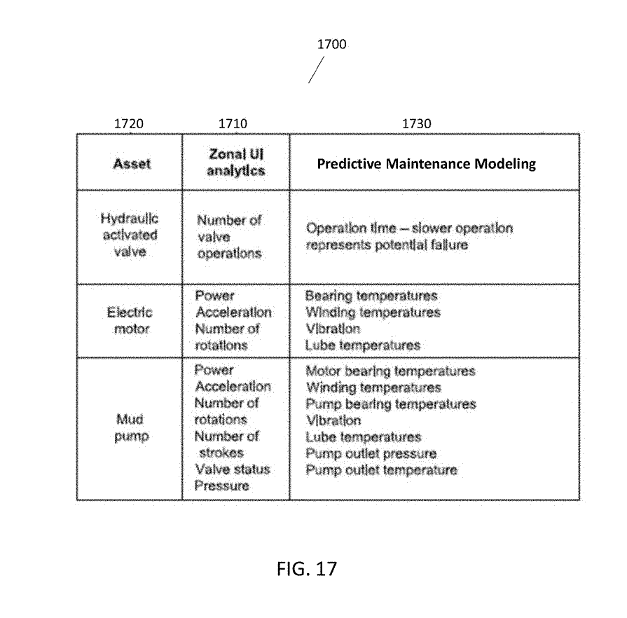

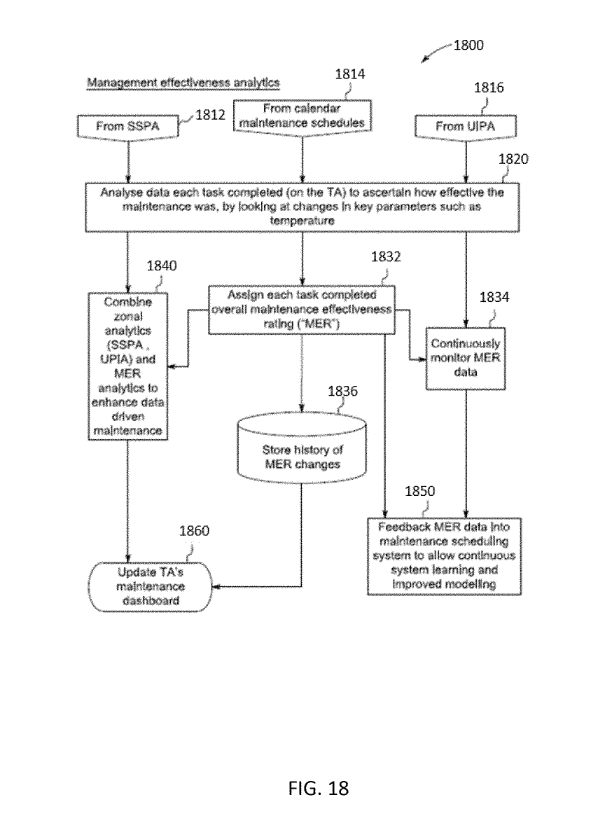

Zonal UI Analytics (1610, 1920) indicate how far maintenance can be extended. A full set of UIFA and SSPA factors is considered for each asset. For example, chart 1700 of FIG. 17 depicts several illustrative skip & shift parameters based upon zonal analytics in column 1710 for selected target assets 1720. Column 1730 includes parameters based on predictive maintenance modeling principles.

FIG. 16A is an exemplary timeline diagram comparing Calendar scheduled maintenance vs Extended maintenance vs Advanced maintenance. The upper timeline 1650 illustrates calendar scheduled maintenance. The middle timeline 1660 illustrates postponed “skip & shift” event movement along the timeline, whereby some maintenance events are delayed until a later time. The lower timeline 1670 illustrates advanced maintenance, whereby one of more events are performed at an earlier time than previously scheduled.

### Maintenance Effectiveness Analytics

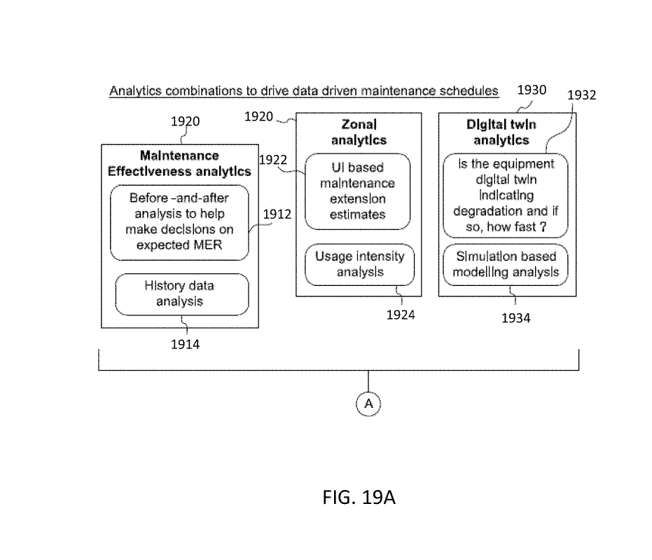

FIGS. 18 & 19A illustrates aspects of Maintenance Effectiveness Analytics 1800 and 1910 as employed in the Embodiments. Through continuous monitoring, maintenance effectiveness information is fed back into the maintenance scheduling calculations to allow a continuous system learning and improvement in modelling capabilities. The management effectiveness analytics include before-and-after analysis 1912 to help make decisions on the expected target asset MER (Management Effectiveness Rating) and history data analysis 1914. Maintenance can be broadly categorized as effective maintenance, ineffective maintenance, and detrimental maintenance.

Also included are zonal analytics 1920, including UI based maintenance extension estimates 1922 and UIA 1924. A digital twin analytics module 1930 includes a digital twin degradation analysis 1932 and a simulation-based modeling analysis 1934.

Effective maintenance occurs where equipment begins to show signs of graceful degradation before maintenance carried out. Equipment returns to nominal status after maintenance. Ineffective maintenance occurs where there is no noticeable change in key operating parameters before or after the maintenance. No SPA alerts are generated before maintenance is carried out and maintenance is carried out unnecessarily. Detrimental maintenance is defined as having degradation in key operating parameters after maintenance.

With the MER system, as maintenance tasks are completed, the maintenance tracking system notifies the server-system. For example, if the maintenance task was a corrective action raised on the basis of a SSPA predictive insight 1812, calendar maintenance schedules 1814, and UIPA 1816, each task is analyzed to ascertain how effective the maintenance was 1820. the asset model should return to its nominal modelled state. For example, predictive maintenance, effectiveness may be determined by looking at key parameters such as temperature, since changes in these parameters show how effective the maintenance has been 1836.

Each maintenance task that has been carried out is assigned 1832 an overall MER. The MER data is combined with zonal analytics (SSPA, UIPA) to enhance data-driven maintenance 1840. The server-system also: continuously monitors MER data 1834, stores history of MER changes 1836, and updates the TA's maintenance dashboard. In addition, MER data is feedback into the maintenance scheduling system to allow continuous system learning and improved modelling 1850. The TA maintenance dashboard is then updated 1860.

### Reporting and Bookkeeping

As indicated earlier, the disclosed invention tracks maintenance status for each TA. For example, see: FIG. 8 (890), FIG. 13 (1330), and FIG. 18 (1860). Comprehensive summaries of maintenance operations are generated providing details of hours spent, material costs and comparisons with original calendar (e.g., see FIGS. 6, 16B). Equipment usage over time is tracked along with associated effect on scheduling (e.g., see FIG. 3).

Audit histories are generated which show any schedule changes and that number of days the maintenance has been extended (e.g., see FIG. 5). Also provided are intuitive user interfaces and dashboards (e.g., see elements 70, 110, 250, 880, 1860), which allow review of maintenance histories and overview of effectiveness.

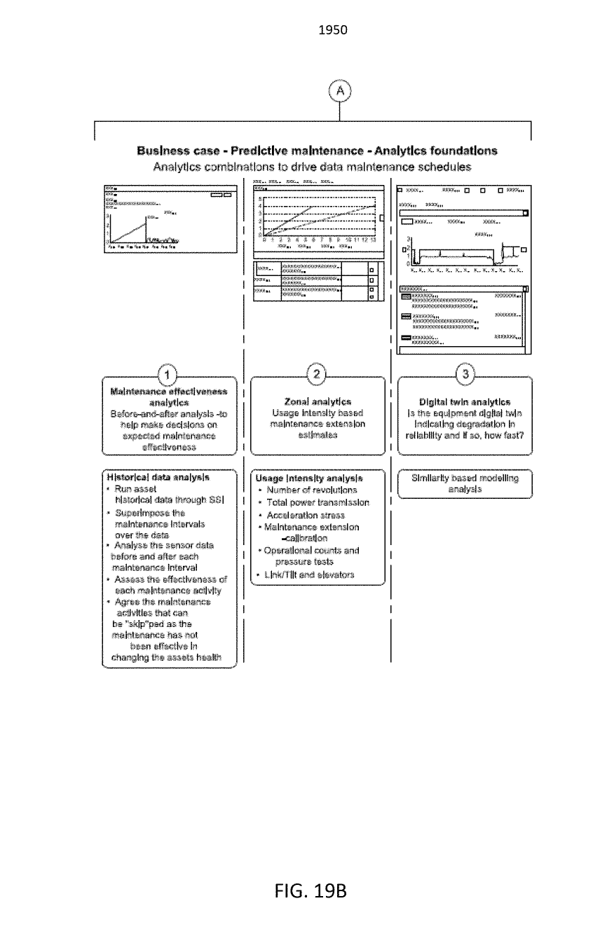

FIG. 19B is an overview 1950 illustrating how combinations of different analytic technologies and methodologies can be combined to drive data-driven predictive maintenance schedules. A few of the analytic technologies are management effectiveness analytics, historical data analysis, zonal analytics, UI analysis, digital twin analytics, and similarly based modelling analysis.

### Benefits

By monitoring all available equipment parameters and utilizing similarity based modelling techniques through the described SSPA system, signs of imminent equipment failure can be detected. Through interfacing directly into the customers maintenance planning tools, additional maintenance can be generated. Additionally, inspection tasks are conducted to resolve issues before breakdown, which can reduce costly unplanned down time and repairs.

By calculation of a UIF factor for each equipment component, maintenance can be postponed for lightly loaded equipment. This process can help avoid taking systems down for maintenance when it's not required, resulting in extended equipment availability. An additional benefit is provided of reducing maintenance consumable costs.

This system has several advantages over existing standalone control and condition based monitoring system. Traditional calendar systems, or CBM, provide local indication of potential equipment failure. The embodiments use principles of big data management to bring maintenance optimization to an enterprise level. This process also moves visibility of maintenance requirements, schedules and equipment conditions to a centralized location, which allows fleet wide analysis and optimization to be performed.

The combination of UI and predictive analytics provides the operator confidence when scheduling maintenance that any abnormalities will be detected prior to a failure. The unique concept of timestamping pre and post maintenance, using the residual values from the predictive model and actual readings, allows visualization of the effectiveness of the maintenance.

### CONCLUSION

This written description uses examples to disclose the invention including the best mode, and also to enable any person skilled in the art to practice the invention, including making and using any devices or apparatuses and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for predicting maintenance on a plurality of equipment components, comprising:
a plurality of computing modules configured to:
(i) retrieve maintenance history and equipment parameters associated with the industrial equipment components from at least one equipment network, and process the maintenance history,
(ii) calculate usage intensity based on the maintenance history and equipment parameters, and
(iii) create modified maintenance schedules of the plurality of equipment components based on the maintenance history and the usage intensity.

2. The system of claim 1, wherein the equipment parameters comprise one or more of analog values, temperature or pressure values, control signals, reference speed and feedback signals of the plurality of equipment components.

3. The system of claim 1, further comprising:
a storage in communication with the computing modules and configured to store historical data obtained and usage intensity data calculated by the computing modules; and
a software application module configured to retrieve and control performance of the modified maintenance schedules.

4. The system of claim 3, wherein the storage and the software application module are remotely located from the plurality of computing modules and the at least one equipment network.

5. The system of claim 1, wherein each computing module comprises:
an internal memory configured to store instructions;
at least one processor configured to receive the instructions from the internal memory and perform (i), (ii) and (iii) by the plurality of computing modules.

6. The system of claim 1, wherein the modified maintenance schedules created comprise a maintenance task timeline including a total of maintenance tasks for the equipment network, and a selected item task including maintenance for a specific piece of equipment of the plurality of equipment components.

7. The system of claim 5, wherein the at least one processor of one computing module of the plurality of computing modules is further configured to:
(i) perform a skip shift operation to determine when to extend existing maintenance tasks of the plurality of equipment components on the equipment network, wherein the skip shift operation comprises determining maintenance extension using historical maintenance data of the plurality of equipment components and skipping routine scheduled maintenance based on the historical maintenance data; and
(ii) retrieving maintenance data in real-time regarding the plurality of equipment components on the at least one equipment network via a computing module of the plurality of computing modules, performing analytics using machine learning processes and shifting a maintenance schedule of the plurality of equipment components based on the analytics.

8. The system of claim 1, wherein the modified maintenance schedules are displayed and controlled via a user display.

9. The system of claim 8, wherein the modified maintenance schedules include maintenance benefit information including usage intensity information and predictive alerts.

10. A method for predicting maintenance of a plurality of equipment components on an equipment network, the method comprising:
retrieving at a first computing module, maintenance history and equipment parameters associated with the plurality of equipment components from the equipment network and processing the maintenance history;
calculating at a second computing module, a usage intensity factor based on the maintenance history and values of the equipment parameter; and
creating at a third computing module, modified maintenance schedules of the plurality of equipment components based on the maintenance history and the usage intensity factor.

11. The method of claim 10, wherein the equipment parameters comprises one or more of analog values, temperature or pressure values, control signals, reference speed and feedback signals of the plurality of equipment components.

12. The method of claim 10, further comprising:
storing the maintenance history and usage intensity factor; and
retrieving and controlling the modified maintenance schedules via a software application module in communication with the first computing module, the second computing module and the third computing module.

13. The method of claim 10, further comprising:
performing, at the third computing module, a skip shift operation to determine when to extend existing maintenance tasks of the plurality of equipment components on the equipment network.

14. The method of claim 13, wherein the skip shift operation comprises:
determining maintenance extension using historical maintenance data of the plurality of equipment components and skipping routine scheduled maintenance based on the historical maintenance data; and
retrieving maintenance data in real-time regarding the plurality of equipment components on the at least one equipment network via the first computing module, and performing analytics using machine learning processes and shifting a maintenance schedule of the plurality of equipment components based on the analytics.

15. The method of claim 10, further comprising:
displaying, at a user display, the modified maintenance schedules.

16. The method of claim 15, further comprising:
displaying at the user display, maintenance benefit information including usage intensity information and predictive alerts.

17. A computer implemented equipment maintenance optimization system for one or more target assets (TA) comprising:
history sensors, configured to detect and transmit maintenance history data from the TA;
usage intensity sensors, configured to detect and transmit wear or usage data from the TA;
a computer server-system, comprising an historian processor (VM1), a usage intensity analytics engine (VM2), and a control processor (VM3);
communications interface means, operatively coupled to said sensors and server-system;
VM1 logic means for performing smart signal predicative analytics (SSPA) computations using received and stored model history data;
VM2 logic means for performing usage intensity factor analytics (UIFA) computations using received and model wear data;
VM3 logical means for combining information from VM1 and VM2 to determine whether maintenance events should take place at previously scheduled times, moved forward in time, or moved back to later times; and
server-system logic means for calculating maintenance effectiveness, and for tracking and displaying maintenance status;
whereby equipment maintenance can be optimally extended when TA is lightly used or brought forward when anomalies indicate imminent failure of the TA.
